(19) United States
(12) Patent Application Publication
(10) Pub. No.: US 2009/0031019 A1
(43) Pub. Date: Jan. 29, 2009

(54) Technique for Graphically Displaying Application Processing Time Distributions in Real-Time

(76) Inventors: Michael J. Burr, Cary, NC (US); Steven D. Clay, Pflugerville, TX (US); Daniel J. Labrecque, Chapel Hill, NC (US); Brian L. White Eagle, Austin, TX (US)

Correspondence Address: DILLON & YUDELL LLP, 8911 N. CAPITAL OF TEXAS HWY., SUITE 2110, AUSTIN, TX, 78759, US

(21) Appl. No.: 11/829,221

(22) Filed: Jul. 27, 2007

(51) Int. Cl. G06F 15/173; G06T 15/00

(52) U.S. Cl. 709/224; 345/419

(57) ABSTRACT

A technique for displaying application processing times includes monitoring incoming packets and outgoing packets as the incoming packets enter and the outgoing packets exit a time critical application. The incoming packets and the outgoing packets are correlated to determine application processing times for the time critical application. Finally, application processing time distributions for a desired time period are graphically displayed for the application processing times.

### BACKGROUND

1. Field

This disclosure relates generally to displaying application processing time distributions and, more specifically, to graphically displaying application processing time distributions in real-time.

2. Related Art

In time critical (e.g., real-time) applications, such as telecommunication applications, virtual world applications, financial applications, etc., it is generally considered desirable to obtain various operational parameters of the time critical applications in order to determine whether the time critical applications are operating in an acceptable manner. As one example, it is generally desirable to ascertain how long it takes a given application to respond to a given input under varying load conditions. One application response time monitoring approach has provided scalar response time data for an application in the form of a mean response time, a minimum response time, and a maximum response time. Another application response time monitoring approach has provided a number of response time buckets in a tabular form, whose entries correspond to the number of times an application responded within an associated response time range. Unfortunately, providing application response times as a mean, minimum, or maximum, or in bucket form may not be particularly useful for rapidly trouble-shooting time critical applications.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is a block diagram of an example network that may be configured to graphically display current and historical application processing time distributions, according to an embodiment of the present disclosure.

FIG. 2 is an example three-dimensional (3D) graphical display of current and historical application processing time distributions, according to one embodiment of the present disclosure.

FIG. 3 is a flowchart of a process for graphically displaying application processing time distributions in real-time, according to one embodiment of the present disclosure.

### DETAILED DESCRIPTION

As will be appreciated by one of ordinary skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but is not limited to, an electronic, magnetic, optical, electromagnetic, infrared, or semiconductor system, apparatus, device, or propagation medium. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, or communicate the program for use by or in connection with an instruction execution system, apparatus, or device.

Computer program code for carrying out operations of the present invention may be written in an object oriented programming language, such as Java, Smalltalk, C++, etc. However, the computer program code for carrying out operations of the present invention may also be written in conventional procedural programming languages, such as the “C” programming language or similar programming languages. The program code may execute entirely on a single computer, on multiple computers that may be remote from each other, or as a stand-alone software package. When multiple computers are employed, one computer may be connected to another computer through a local area network (LAN) or a wide area network (WAN), or the connection may be, for example, through the Internet using an Internet service provider (ISP).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

According to various aspects of the present disclosure, techniques are disclosed herein for graphically display application response time distributions in real-time. In at least one embodiment, current application response time distributions are graphically displayed with historical application response time distributions in respective planes. According to another aspect of the present disclosure, commitments are also graphically displayed in conjunction with the current and historical application response time distributions. Graphically displaying application response time distributions facilitates rapid determination of whether a time critical (e.g., real-time) application is performing in an acceptable manner. The techniques disclosed herein are particularly advantageous when trouble shooting a time critical application that runs on top of a relatively large set of middleware that may exhibit unpredictable behavior.

To enhance readability, the application response time distributions may be graphically displayed on a logarithmic scale. In general, graphically displaying the application response time distributions on a logarithmic scale provides more detail at higher percentages. According to various aspects of the present disclosure, information readability may be further enhanced by providing the capability to: zoom-in on parts of an image; dynamically change a viewing angle; specify an application response time depth, specify a time duration between application response time distribution planes; and switch between a standard distribution view and a cumulative distribution view. As used herein, the term “coupled” includes both a direct electrical connection between blocks or components and an indirect electrical connection between blocks or components achieved using intervening blocks or components.

According to one aspect of the present disclosure, a technique for displaying application processing time distributions includes monitoring incoming packets and outgoing packets as the incoming packets enter and the outgoing packets exit a time critical (e.g., real-time) application. The incoming packets and the outgoing packets are correlated to determine application processing times for the application. Finally, application processing time distributions, which correspond to the application processing times for a desired time period, are graphically displayed.

According to another aspect of the present disclosure, a system is disclosed that includes a processor that is coupled to a display. The processor is in communication with a sensor that is configured to monitor incoming packets and outgoing packets as the incoming packets enter and the outgoing packets exit a time critical (e.g., real-time) application. The sensor is also configured to correlate the incoming packets and the outgoing packets to determine application processing times for the time critical application. Finally, the processor causes application processing time distributions, corresponding to the application processing times, for a desired time period to be graphically provided on the display.

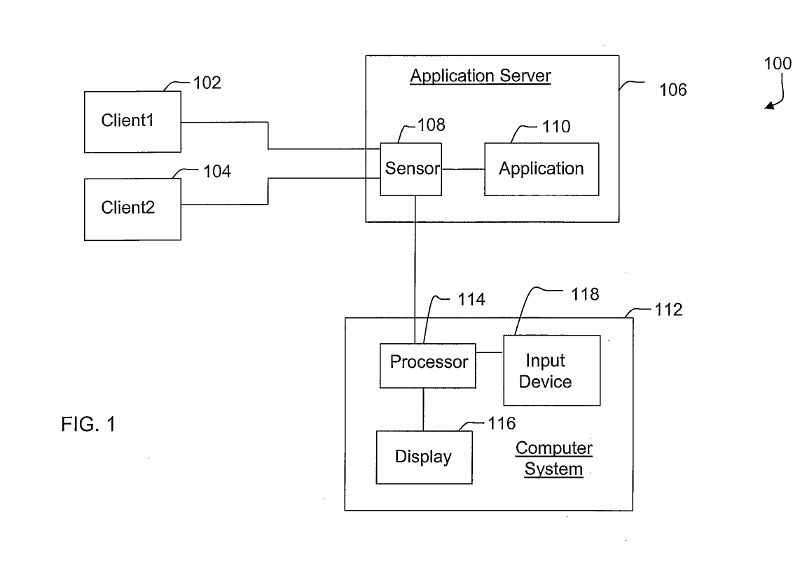

With reference to FIG. 1, an example network (a computer network, a telecommunications network, etc.) 100 that is configured to graphically display application processing time distributions, according to the present disclosure, is illustrated. The network 100 may be, for example, part of an Internet protocol multimedia subsystem (IMS). As is shown, the network 100 includes a first client 102, a second client 104, an application server 106 (which includes a sensor 108 and a time critical (e.g., real-time) application 110) and a computer system 112 (which includes a processor 114 coupled to an input device 118 and a display 116). The sensor 108 is essentially instrumentation that is added to a container of the application 110. The first and second clients 102 and 104 may be, for example, voice over Internet protocol (VoIP) customer premises equipment (CPE) that communicate using a session initiation protocol (SIP) or computer systems.

When the network 100 is configured to handle VoIP traffic, the techniques disclosed herein may be utilized to determine if the application 110 (in this case a VoIP application) is operating in an acceptable manner. For example, when the first client 102 attempts to establish a VoIP call with the second client 104, the first client 102 may transmit an invite SIP request, which is routed to the application server 106 (which in this case is acting as an SIP proxy). In this case, the sensor 108 is configured to detect (by, for example, examining an incoming packets) the invite SIP request from the first client 102 and start a counter. The sensor 108 then monitors output (by, for example, examining outgoing packets) of the application 110 for an SIP response to the invite SIP request from the first client 102. The response may be, for example, an information response (e.g., 100 trying), a successful response (e.g., 200 OK), a redirection response (e.g., 301 moved permanently), a client failure response (e.g., 404 client not found), etc.

When the sensor 108 determines that the SIP response corresponds to the SIP request, the counter is stopped and the application response time is reported to an appropriate entity, e.g., the computer system 112 (which in this case executes a program to graphically display application processing time distributions). It should be appreciated that the sensor 108 may maintain an application appropriate number of counters to track a desired number of simultaneous or near simultaneous calls.

Alternatively, the first and second clients 102 and 104 may correspond to computer systems coupled to the application server 106 via one or more Internet service providers (ISPs). In this case, the application server 106 may correspond to a web page server for a search engine. According to this example, a user operating one of the clients 102 and 104 may access a web page of the application server 106 (by, for example, entering an appropriate uniform resource locator (URL) into a web browser associated with one of the clients 102 and 104) to perform a search on a term of interest. In this case, the sensor 108 may detect the input of the search term, start a counter, and monitor the application 110 for a response. Upon receiving a response associated with the input of the search term, the counter is stopped and the application response time is graphically displayed in conjunction with other simultaneous or near simultaneous response times of the application 110 in an application response time distribution.

As is illustrated, the computer system 112 is coupled to the sensor 108. The computer system 112 may be utilized, for example, by a network administrator that is attempting to troubleshoot operation of the application server 106. The processor 114 of the computer system 112 is in communication with the sensor 108 and receives input from the sensor 108 which (in this case) corresponds to a number of application processing times of the application 110 at a given point in time. As is further discussed below, the processor 114 is configured to provide input to the display 116 responsive to the sensor 108. Alternatively, the display 116 may be, for example, included in a terminal that is associated with the server 106.

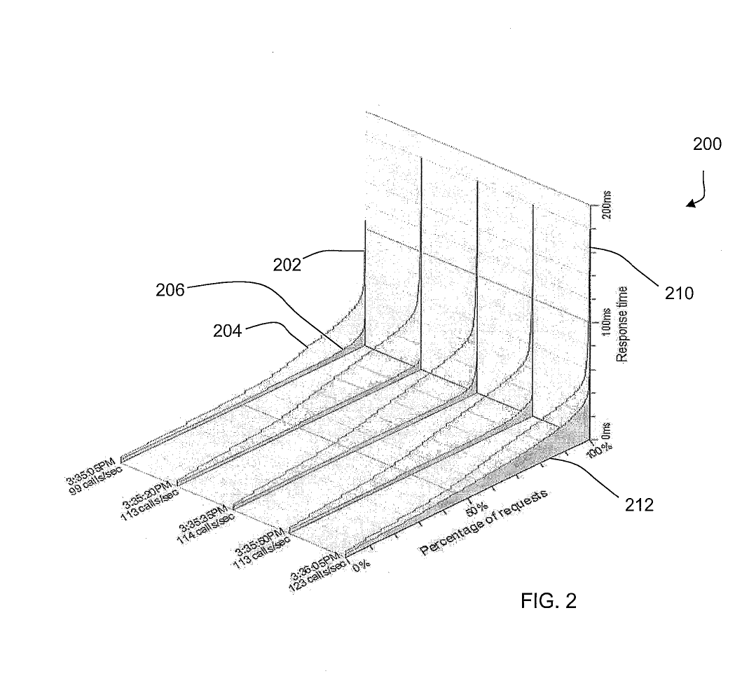

Turning to FIG. 2, an example three-dimensional (3D) graphical display 200 of multiple application response time distributions 206 are illustrated according to one aspect of the present disclosure. As is depicted, the graphical display 200 includes a number of respective planes (e.g., spaced at fifteen second intervals) 202, which are utilized to report the application response time distributions 206 for a given time in conjunction with respective commitments 204. In the graphical display 200, a vertical axis 210 corresponds to response time and a horizontal axis 212 corresponds to a percentage of requests whose application processing time falls within a given percentage. The respective commitments 204 are each associated with one of the respective planes 202. In this case, the commitments 204 are the response time distributions that an application guarantees that the application can satisfy. In this manner, a commitment is similar to a service level agreement (SLA). To increase readability, the commitments 204 and the response time distributions 206 may be graphed in different colors (e.g., blue and green, respectively). When one of the commitments 204 is exceeded, an associated one of the application response time distributions 206 may change to a different color (e.g., red). As is illustrated, as the number of calls per second increases, the performance of the application decreases (e.g., at 123 call/sec the application response (processing) times have increased as contrasted with, for e.g., the application response times at 99 calls/sec).

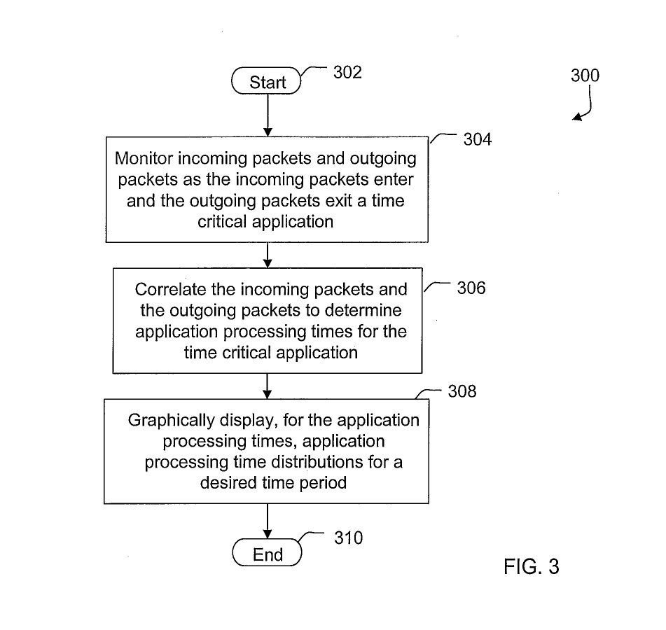

Moving to FIG. 3, a process 300 for graphically displaying application processing times is illustrated. In block 302, the process 300 is initiated at which point control transfers to block 304. In block 304, incoming packets and outgoing packets are monitored by the sensor 108 as the incoming packets enter and the outgoing packets exit the time critical application 110. Next, in block 306, the incoming packets and the outgoing packets are correlated (e.g., by reading information from each of the packets to correlate the incoming packets and the outgoing packets) by the sensor 108 to determine application processing times for the application 110. Then, in block 308, application processing time distributions, for the application processing times, are graphically displayed on, for example, the display 116 of the computer system 112 for a desired time period. The application processing time distributions may be, for example, semi-transparent to facilitate viewing of previous planes. Following block 308, control transfers to block 310, where the process 300 returns to a calling process. Accordingly, techniques have been disclosed herein that readily facilitate graphical display of application processing times in real-time.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method of displaying application processing times, comprising:
monitoring incoming packets and outgoing packets as the incoming packets enter and the outgoing packets exit a time critical application;
correlating the incoming packets and the outgoing packets to determine application processing times for the time critical application; and
graphically displaying, for the application processing times, application processing time distributions for a desired time period.

2. The method of claim 1, wherein the correlating further comprising:
reading information from each of the packets to correlate the incoming packets and the outgoing packets.

3. The method of claim 1, wherein the graphically displaying further comprising:
graphically displaying the application processing time distributions for the desired time period in three-dimensions, wherein the application processing time distributions are semi-transparent.

4. The method of claim 1, wherein the graphically displaying further comprising:
graphically displaying the application processing time distributions for the desired time period in three-dimensions along with associated commitments.

5. A system, comprising:
a processor in communication with a sensor, wherein the sensor is configured to monitor incoming packets and outgoing packets as the incoming packets enter and the outgoing packets exit a time critical application and correlate the incoming packets and the outgoing packets to determine application processing times for the time critical application; and
a display coupled to the processor, wherein the processor is configured to cause the display to graphically provide the application processing times in the form of application processing time distributions for a desired time period.

6. The system of claim 5, wherein the sensor is further configured to read information from each of the packets to correlate the incoming packets and the outgoing packets.

7. The system of claim 5, wherein the display provides the application processing time distributions for the desired time period in three-dimension.

8. The system of claim 5, wherein the display provides the application processing time distributions for the desired time period in three-dimension along with associated commitments.
